(19) United States
(12) Patent Application Publication
(10) Pub. No.: US 2008/0203880 A1
(43) Pub. Date: Aug. 28, 2008

(54) Plasma display device

(76) Inventor: Hyuk Kim, Suwon-si (KR)

Correspondence Address: ROBERT E. BUSHNELL, 1522 K STREET NW, SUITE 300, WASHINGTON, DC, 20005-1202, US

(21) Appl. No.: 11/902,204

(22) Filed: Sep. 19, 2007

(30) Foreign Application Priority Data
Feb. 23, 2007 (KR) 10-2007-18664

(51) Int. Cl. H01J 61/52; H01J 17/49

(52) U.S. Cl. 313/45; 313/582

(57) ABSTRACT

The present invention relates to a plasma display panel device that includes a plasma display panel, a chassis base, and a heat-radiating medium disposed between the plasma display panel and the chassis base. The heat-radiating medium transfers heat generated from the plasma display panel into the chassis base. The heat-radiating medium is constructed to easily attach the chassis base to the plasma display panel, and to facilitate the separation of the chassis base from the plasma display panel. The heat-radiating medium further includes a first adhesive layer, a second adhesive layer, and a heat-radiating layer disposed between the first adhesive layer and the second adhesive layer. The heat-radiating medium can include a thermally conductive filler.

### CLAIM PRIORITY

This application makes reference to, incorporates the same herein, and claims all benefits accruing under 35 U.S.C. §119 from an application for PLASMA DISPLAY DEVICE earlier filed in the Korean Intellectual Property Office on the 23 Feb. 2007 and there duly assigned Serial No. 10-2007-0018664.

### BACKGROUND OF THE INVENTION

1. Field of the Invention

The present invention relates to a plasma display device, and more particularly, to a plasma display device that includes a plasma display panel, a chassis base, and a heat-radiating medium formed between the plasma display panel and the chassis base. The heat-radiating medium efficiently radiates heat generated from a plasma display panel, and facilitates the separation of the plasma display panel from the chassis base.

2. Description of the Prior Art

A plasma display device can be made large in screen size, and is thinner than a CRT (Cathode Ray Tube) display, that has been used as a display device for decades. Therefore, the plasma display device has been attracted as a next generation display device. The plasma display device displays an image using a gas discharge phenomenon, and has an excellent display capabilities in characteristics such as display capacity, brightness, contrast, afterimage, viewing angle and the like. The plasma display device is also considered as a display device that can replace the CRT displays, because the plasma display device is easily made larger in screen size than other display devices, is thinner in thickness reducing the occupied space of the device, and is characterized as one of the best devices for the future high-quality digital television.

The plasma display device is a device for displaying an image on a plasma display panel by using a gas discharge phenomenon. Due to the high temperature of the gas discharge process, a large amount of heat is generated from the plasma display panel (PDP) of the plasma display device. In order to effectively radiate the heat generated from a PDP, a contemporary plasma display device has a chassis base, on which a PDP of the plasma display device is attached. The chassis base is made of a material having excellent thermal conductivity. The chassis base is typically attached to the PDP by the use of an adhesive. The adhesive does not have thermal conductivity, and another member to improve the heat radiation is necessary. A heat-radiating sheet (or a thermal conductive sheet) can be interposed between the PDP and the chassis base to more efficiently radiate the heat generated from the PDP into the outside through the chassis base. In order to accommodate the heat-radiating sheet, the adhesive is formed on periphery of the PDP, and the hear-radiating sheet is disposed between the PDP and the chassis base, partly or completely surrounded by the adhesive.

In the contemporary structure of the plasma display device, a problem arises in the case that the PDP device requires a repair. In order to repair the plasma display devices, it is necessary to separate the PDP from the chassis base. The contemporary method to separate the PDP from the chassis base is to melt the adhesive by applying heat to the adhesive by an external heating device such as a heating lamp.

If the PDP is separated from the chassis base by reducing the adhesion of the adhesive using heating lamp, there is a problem that a long process time is required to sufficiently reduce the adhesion of the adhesive. Another problem is that the PDP is heated to high temperature by heating lamp, and thus a filling port to which a discharge gas is charged can be broken. Still another problem is that it is impossible to reuse chassis base, and therefore the overall cost increases and the recycling rate decreases.

### SUMMARY OF THE INVENTION

The present invention provides a solution for the aforementioned problems by providing a new structure for heat radiation. An object of the present invention is to provide a plasma display device, in which a plasma display panel (PDP) closely adheres to a chassis base without using an adhesive. In the plasma display device of the present invention, heat generated from the PDP is efficiently radiates into outside, and the PDP is easily separated from the chassis base, which increases the recycling rate reducing overall cost.

According to an aspect of the present invention for accomplishing the aforementioned object, a plasma display device of the present invention includes a plasma display panel for display an image, a chassis base coupled to the plasma display panel, and a heat-radiating medium interposed between the plasma display panel and the chassis base. The heat-radiating medium attaches the chassis base to the plasma display panel. The heat-radiating medium includes a first adhesive layer adhering to the plasma display panel, a second adhesive layer adhering to the chassis base, and a heat-radiating layer disposed between the first adhesive layer and the second adhesive layer. The heat-radiating layer radiates heat generated from the plasma display panel.

The heat-radiating layer can be made of a thermally conductive material such as an acryl-based resin, a silicon-based resin, or a urethane-based resin.

The plasma display device may further include a thermally conductive filler being dispersed in the heat-radiating medium. The thermally conductive filler can be made of a material such as a metal, an alloy, a ceramic, or a polymer molding.

The heat-radiating medium can have a thickness between about 0.5 millimeters to about 2.0 millimeters.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1a is a sectional view illustrating a plasma display device;

FIG. 1b is a sectional view illustrating a system for separating a plasma display from a chassis base;

FIG. 2 is a schematic perspective view illustrating a plasma display device constructed as an embodiment of the present invention;

FIG. 3 is a schematic cross-sectional view illustrating a plasma display device of the present invention; and

FIG. 4 is an enlarged cross-sectional view illustrating a heat-radiating medium of the plasma display device of the present invention.

### DETAILED DESCRIPTION OF PREFERRED EMBODIMENTS

Hereinafter, exemplary embodiments of the present invention will be described in detail with reference to the accompanying drawings.

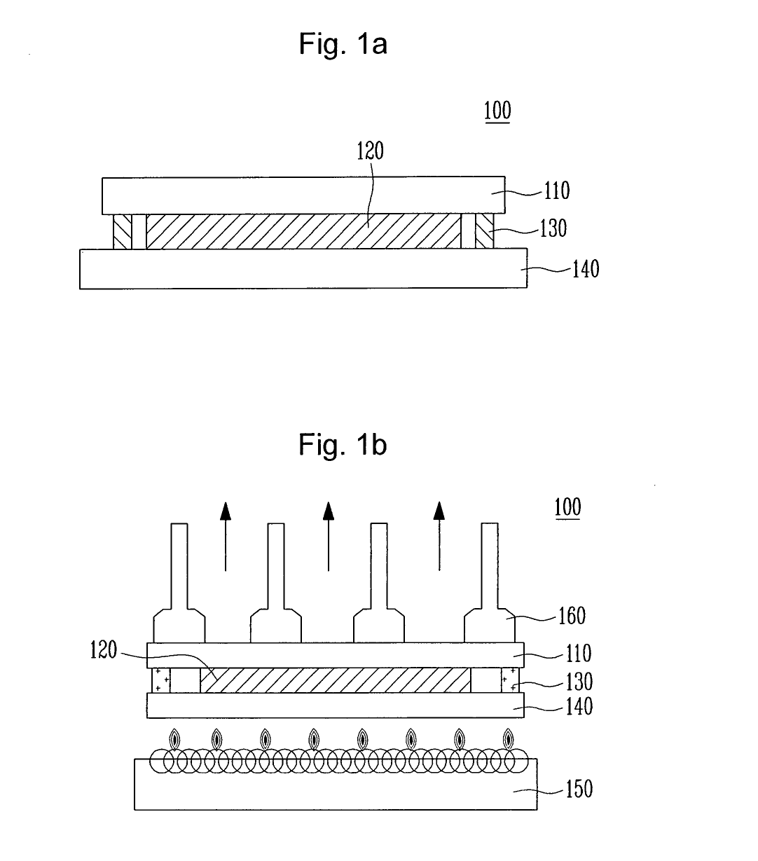

FIG. 1a is a cross-sectional view illustrating a plasma display device. Referring to FIG. 1a, plasma display device 100 includes plasma display panel (PDP) 110, chassis base 140, and adhesive film 130 to attach PDP 110 to chassis base 140. PDP 110 includes a front substrate, a rear substrate, and a plurality of discharge cells formed between the front substrate and the rear substrate. If images are displayed through the front substrate, chassis base 140 for radiating heat generated from PDP 110 can be coupled to the rear substrate of PDP 110. Chassis base 140 is coupled to PDP 110 through adhesive film 130 that is formed on periphery of a rear surface of PDP 110.

Heat-radiating sheet 120 is formed between PDP 110 and chassis base 140 in a manner that heat-radiating sheet 120 can be closely arranged to both of PDP 110 and chassis base 140. Heat-radiating sheet 120 can be formed of an acryl-based resin, a silicon-based resin, and the like. Heat-radiating sheet 120 radiates heat, which is generated from PDP 110, to the outside through chassis base 140.

FIG. 1b illustrates a system for separating a plasma display panel (PDP) from a chassis base. Referring to FIG. 1b, heating lamp 150 is provided under chassis base 140, and is heated up to approximately 450° C. At the high temperature, the adhesion of adhesive film 130 formed between PDP 110 and chassis base 140 is reduced. In this case, whenever repairer 160 pulls PDP 110 up, the adhesion of adhesive film 130 is not strong enough to hold PDP 110 and chassis base 140 together, and therefore, PDP 110 is separated from chassis base 140 while repairer 160 pulls PDP 110 upwards.

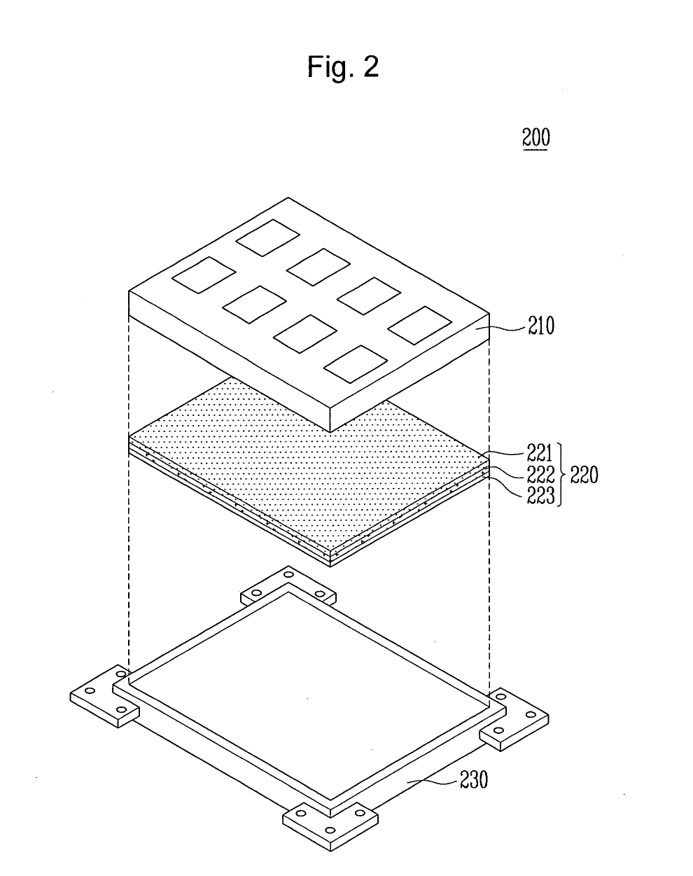

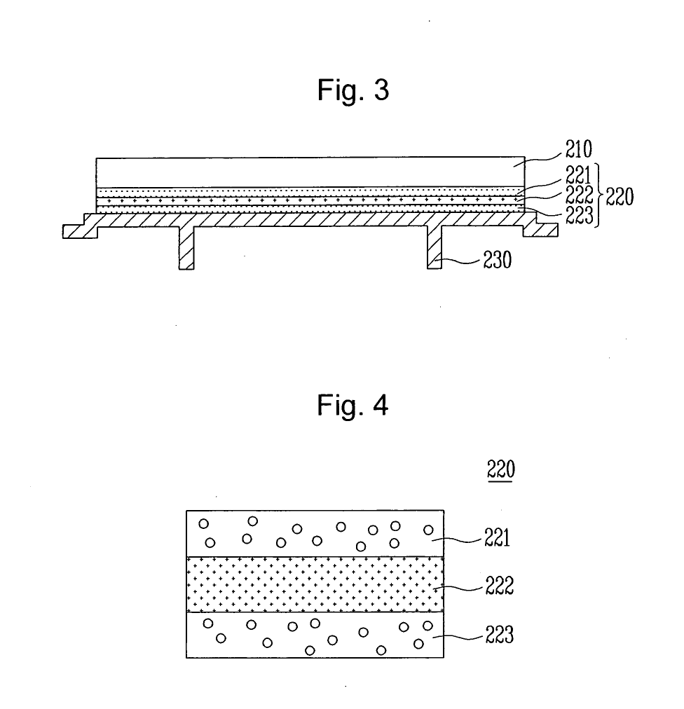

FIG. 2 is a schematic perspective view illustrating a plasma display device constructed as an embodiment of the present invention. FIG. 3 is a schematic cross-sectional view illustrating a plasma display device of the present invention. FIG. 4 is an enlarged cross-sectional view illustrating a heat-radiating medium of the present invention.

Referring to FIGS. 2 to 4, plasma display device 200 includes plasma display panel (PDP) 210, chassis base 230 arranged to be coupled to PDP 210, and heat-radiating medium 220 interposed between PDP 210 and chassis base 230 to attach PDP 210 to chassis base 230. Heat-radiating medium 220 includes first adhesive layer 221, heat-radiating layer 222 formed on first adhesive layer 221, and second adhesive layer 223 formed on heat-radiating layer 222.

PDP 210 has a front surface and a rear surface. Images are displayed on the front surface of PDP 210. Chassis base 230 for radiating heat generated from PDP 210 to the outside is coupled to PDP 210. Specifically chassis base 230 can be coupled to the rear surface of PDP 210. Chassis base 230 is made of a material having excellent thermal conductivity, and can be formed of a metal material such as aluminum by a die casting process or a press process. Furthermore, a drive circuit for driving plasma display device 200 can be mounted on the rear surface of chassis base 230 (the opposite surface to the side to which PDP is attached).

Heat-radiating medium 220 is provided between PDP 210 and chassis base 230. Heat-radiating medium 220 transfers heat generated from PDP 210 to chassis base 230, and attaches PDP 210 to chassis base 230. Heat-radiating medium 220 includes first adhesive layer 221 attached to PDP 210, second adhesive layer 223 attached chassis base 230, and heat-radiating layer 222 interposed between first adhesive layer 221 and second adhesive layer 223. First adhesive layer 221 and second adhesive layer 223 are made of a material having adhesive strength, and are attached to PDP 210 and chassis base 230, respectively. Heat-radiating layer 222 absorbs and stores heat transferred from PDP 210, or radiates the heat to the outside. Heat-radiating layer 222 is made of a material having thermal conductivity. For example, at least one of an acryl-based resin, a silicon-based resin, and a urethane-based resin can be formed in a single layer or in multilayer to form heat-radiating layer 222.

Furthermore, a filler having thermal conductivity can be dispersed inside heat-radiating layer 222. The filler having thermal conductivity may be made of a material such as a metal powder, an alloy powder, a ceramic, or a polymer molding. In this case, the volume ratio of the material of heat-radiating adhesive layer 222 to the filler can be 10:1.8˜10:2.2. In the higher ratio, heat-radiating efficiency the heat-radiating adhesive layer 222 is deteriorated, and in the lower ratio, the adhesion of the heat-radiating adhesive layer 222 is considerably reduced.

In another embodiment, heat-radiating layer 222 itself can be made of the thermally conductive filler.

The filler may also be distributed in one or both of first and second adhesive layers 221 and 223. Thus, in this case, the filler dispersed-first and the filler dispersed-second adhesive layers can be thermally conductive. The thermally conductive filler is distributed in a manner that the filler does not impede the adhesion of first and second adhesive layers 221 and 223. For example, the volume ratio of the material of each of first and second adhesive layers 221 and 223 to the filler can be 10:2.8˜10:3.2. In the higher ratio, heat-radiating efficiencies of the first and second adhesive layers 221 and 223 are deteriorated, and to separate the heat-radiating medium 220 by heating is difficult. In the lower ratio, the adhesion of the heat-radiating adhesive layer 222 is considerably reduced.

Therefore, heat-radiating medium 220 can have thermal conductivity by providing the thermally conductive filler having an appropriate dimension inside heat-radiating medium 220. The filler is expanded by the heat generated during the operation of PDP 210, and enables the heat generated from PDP 210 to be transferred to chassis base 230. For example, when PDP 210 is driven (typically at temperature below 100° C.), the filler distributed in heat-radiating medium 220 expands, so that it transfers the heat transferred from PDP 210 to chassis base 230. Hence, the heat transferred to chassis base 230 can radiate into the outside. Furthermore, if the filler is distributed in first and second adhesive layers 221 and 223, it is possible to more easily separate PDP 210 from chassis base 230. For example, by heating heat-radiating medium 220 up to temperature above 120° C. in an oven or by eliminating the adhesive characteristic of first and second adhesive layers 221 and 223 in a high temperature chamber that is set to temperature above 120° C., it is possible to separate PDP 210 from chassis base 230.

The thickness of heat-radiating medium 220 is approximately 0.5 mm to 2.0 mm, and preferably is about 0.95 mm. If the thickness of heat-radiating medium 220 is smaller than 0.5 mm, the degree of the heat radiation and the adhesion of heat-radiating medium 220 is considerably reduced. If the thickness of heat-radiating medium 220 is greater than 2.0 mm, the efficiency of the heat radiation is reduced, as the distance between PDP 210 and chassis base 230 becomes larger.

Heat-radiating medium 220, which is provided with first and second adhesive layers 221 and 223, facilitates the coupling between PDP 210 and chassis base 230 without using an additional adhesive film to couple PDP 210 to chassis base 230. The thermally conductive filler, which is distributed in heat-radiating medium 220, facilitates the separation of PDP 210 from chassis base 230, when heated, without any damage to PDP 210 or chassis base 230. Thus it is possible to carry out the module-repair of plasma display panel device 200 more conveniently.

According to the present invention, the PDP and the chassis base are closely attached to each other by the first and second adhesive layers of the heat-radiating medium without using an additional adhesive film so as to easily separate the panel from the chassis base of the plasma display panel device.

The PDP can be easily attached to or separated from the chassis base by distributing a thermally conductive filler in the heat-radiating medium, and thus it is possible to reduce the process time of module repair and improve the efficiency of the repair process.

Hence, when repairing the plasma display panel device, it is possible to prevent the plasma display panel from being broken, and to increase the recycling rate by reusing the chassis base.

Although preferred embodiments of the present invention have been described for illustrative purpose, those skilled in the art will appreciate that various modifications and changes thereof are possible without departing from the scope and spirit of the present invention, and all modifications and changes are intended to be included within the description of the claims.

What is claimed is:

1. A plasma display device comprising:
a plasma display panel for display an image;
a chassis base coupled to the plasma display panel; and
a heat-radiating medium interposed between the plasma display panel and the chassis base, the heat-radiating medium attaching the chassis base to the plasma display panel, the heat-radiating medium comprising:
a first adhesive layer adhering to the plasma display panel;
a second adhesive layer adhering to the chassis base; and
a heat-radiating layer disposed between the first adhesive layer and the second adhesive layer, the heat-radiating layer radiating heat generated from the plasma display panel.

2. The plasma display device as claimed in claim 1, comprised of the heat-radiating layer being made of a thermally conductive material.

3. The plasma display device as claimed in claim 2, comprised of the thermally conductive material of the heat-radiating layer being selected from the group consisting of an acryl-based resin, a silicon-based resin, and a urethane-based resin.

4. The plasma display device as claimed in claim 1, further comprising:
a thermally conductive filler being dispersed in the heat-radiating medium.

5. The plasma display device as claimed in claim 4, comprised of the thermally conductive filler being made of a material selected from the group consisting of a metal, an alloy, a ceramic, and a polymer molding.

6. The plasma display device as claimed in claim 1, comprised of the heat-radiating medium having a thickness between about 0.5 millimeters to about 2.0 millimeters.

7. The plasma display device as claimed in claim 4, wherein a volume ratio of the material of the heat-radiating layer to the thermally conductive filler is 10:1.8-10:2.2.

8. The plasma display device as claimed in claim 1, further comprising:
a thermally conductive filler being dispersed in each of first and second adhesive layers.

9. The plasma display device as claimed in claim 8, wherein a volume ratio of the material of each of first and second adhesive layers to the thermally conductive filler is 10:2.8-10:3.2.
